(19) United States
(12) Patent Application Publication
(10) Pub. No.: US 2003/0042338 A1
(43) Pub. Date: Mar. 6, 2003

(54) Fluid spray system

(75) Inventor: Manfred Dankert, Rodermark (DE)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: ITW Oberflachentechnik GmbH & Co. KG

(21) Appl. No.: 10/211,274

(22) Filed: Aug. 5, 2002

(30) Foreign Application Priority Data
Aug. 29, 2001 (DE) 101 42 228.8

(51) Int. Cl. B05B 1/00

(52) U.S. Cl. 239/600

(57) ABSTRACT

A fluid spray system in particular for a spray-coating material, comprising a spray nozzle (2) detachably affixed by a rapid rotational connection assembly (22, 24, 26, 28, 30) to a main body (4).

The present invention relates to a fluid spray system, in particular for a liquid coating material, as defined by the preamble of claim 1.

Accordingly the invention concerns a fluid spray system containing a spray nozzle detachable affixed to a main body which is crossed by at least one fluid duct feeding fluid to the spray nozzle.

The expression “fluid” used herein is to be construed generically to include all fluid materials, in particular liquids such as liquid coating materials, cleaning liquids, water, glues, means separating objects, lubricants, emulsions, acids, bases, lyes etc; furthermore coating powders pneumatically conveyed in a flow of pressurized gas such as compressed air, also pressurized gases, for instance compressed air or nitrogen to blow off (cleaning) or cooling objects, for instance spray devices, or, as regards spray devices, to atomize and shape the spray jet or to clean coating-material ducts or objects to be coated or other objects. The fluid may be electrically conducting or not.

The fluid spray system may be devoid of or comprise at least one high-voltage electrode to electrostatically charge the fluid. Even though the preferred field of application of the invention is a liquid coating material, this invention also is appropriate for powder coating materials being conveyed pneumatically in a flow of pressurized gas, in particular a flow of compressed air.

As regards a liquid-coating material spray system of the state of the art, the spray nozzle is detachable affixed to the main body by a thread they mutually subtend and is secured in position by a threaded ring. As a result, when the spray nozzle must be changed and/or removed for purposes of cleaning, considerable time must be spent to screw together or unscrew the threaded ring and the spray nozzle. When the spray nozzle is screwed on, that angular position must be ascertained by rotating it to-and-fro at which the initial threading of the spray nozzle shall be aligned with the initial threading of the main body. Accordingly a tool was required to overcome the large torque involved in affixing and removing the spray nozzle.

In general spray systems for spray-coating materials are called “spray guns” regardless of their being fitted with a grip for manual operation or being designed for affixation to a machine, for instance a jack or a robot arm. The invention covers all applications.

A comparable spray system is known from the European patent document 0 846 498 A1A2. An electrostatic spray system fitted with a high-voltage electrode is known from the U.S. Pat. No. 3,731,145.

The objective of the present invention is to facilitate spray-nozzle mounting and dismounting. The main body and the spray nozzle detachably affixed to it shall be designed in simple and operationally reliable manner. Even at high fluid pressures, leakages between the main body and the spray nozzle shall be precluded by a design which while simple shall nevertheless is effective and of long service life.

This objective is attained by the features of claim 1 of the present invention.

According to the above claim, this objective is attained in that a separable rotary quick-connect assembly is provided by the spray nozzle and the main body, wherein the spray nozzle's rear end is the male connection element and the front end of the main body's fluid duct is the female connection element corresponding to said male connection element, in that the spray nozzle is fitted with at least one locking protrusion pointing away transversely from said male connection element and in that the female connection element comprises at least one rearward-facing locking surface behind which the minimum of one locking protrusion may be rotated when the spray nozzle is fully axially inserted into said female connection element in order to lock the spray nozzle in said axial position.

Advantages of the Invention.

The invention allows assembling the spray nozzle to and disassembling it from the main body in simple and rapid manual manner. No assembly tool is needed. An axial displacement defined by the connector assembly and a small rotation of less than 360° will suffice, and in some embodiments only a rotation less than 10° is required.

Further advantages of the invention are defined in the dependent claims.

The invention is described below in illustrative embodiments and in relation to the attached drawings.

FIG. 1 is a longitudinal section of a coating-material spray system of the present invention and is shown in exploded view to comprise a spray nozzle axially configured in front of a main body, the upper half of the spray nozzle being shown in axial section and its lower half in sideview,

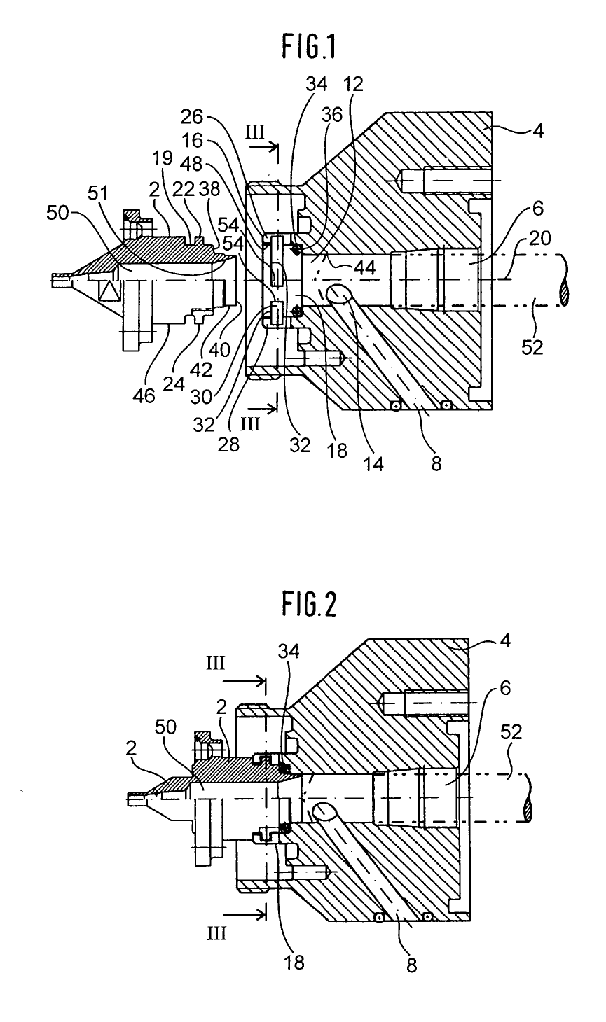

FIG. 2 is an axial view of the spray system of FIG. 1 after the spray nozzle was inserted into the main body,

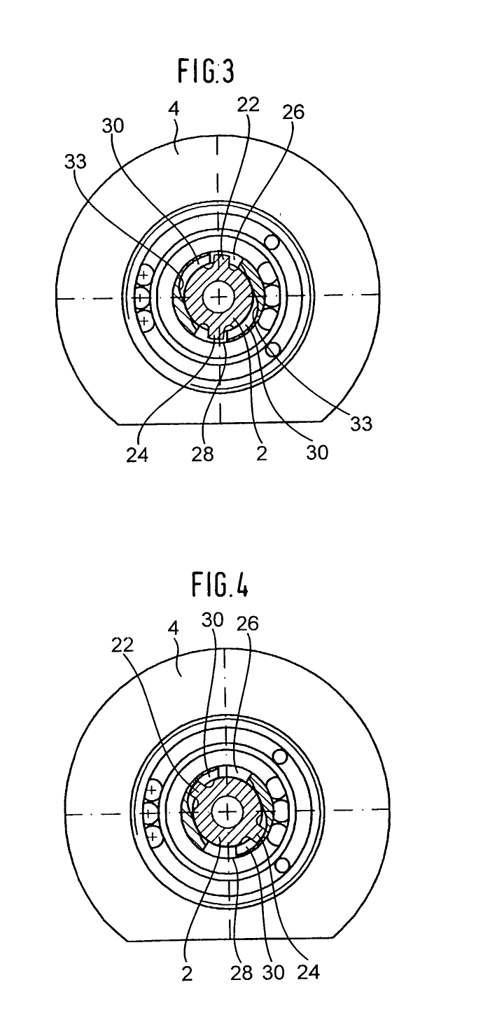

FIG. 3 is a cross-section in the plane III-III of FIG. 2 of the spray nozzle in its fully inserted axial position but before it is axially locked,

FIG. 4 shows the cross-section of FIG. 3, however after the spray nozzle was rotated relative to the main body from the unlocked into the locked angular position, and

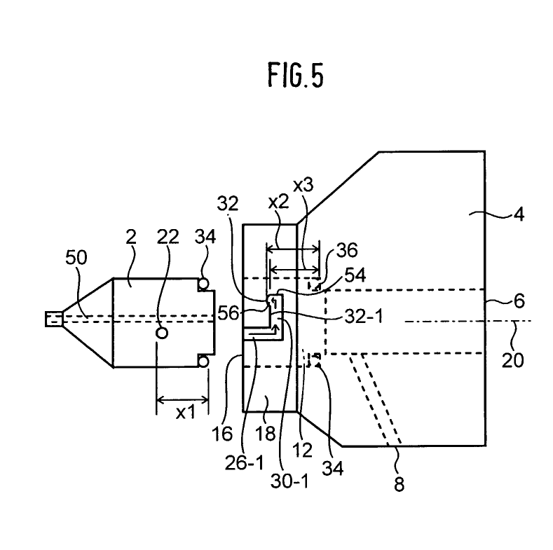

FIG. 5 is an exploded sideview of another embodiment of a spray system of the present invention before the spray nozzle is inserted into the main body.

The spray system of the invention shown in FIGS. 1 through 4 comprises a spray nozzle 2 detachably affixed to the front end of a main body 4. This spray system can spray all kinds of fluids. A coating material shall be illustrated in the following discussion. This coating material may be powder conveyed in liquid or pneumatic or pneumatic manner. A continuous borehole 6 entered obliquely by a coating-material feed duct 8 runs through the main body 4. The segment 12 of the borehole 6 between the mouth 14 of the feed duct 8 for such fluids and the downstream end 16 of said borehole 6 is denoted hereafter as “coating-material duct 6”. The front end 18 of the coating-material duct 12 is designed to act as a female connection element 18 which may receive the spray nozzle 2 by means of its rear zone designed as a male connection element 19 by axial insertion relative to the center axis 20 of the coating-material duct 12. The spray nozzle 2 is fitted with at least one, preferably two radial locking protrusions 22 and 24 consisting of inserted pins or preferably being integral with the material of the spray nozzle 2 and projecting radially from diametrically opposite sides of the male connection element 19. Further ducts for further fluids may run through the main body 4 and the spray nozzle 2.

At the wall of the female connection element 18, the main body 4 comprises two diametrically opposite longitudinal slots 26 and 28 transversely communicating with an inner circumferential channel 30. The longitudinal slots 28 and the inner circumferential channel 30 exhibit a width only slightly exceeding the size of the locking protrusions 22 and 24 in order to receive and guide them and jointly with them to constitute a kind of quick bayonet connect device by means of which the spray nozzle 2 can be affixed to or loosened from the main body 4 by a plug-in or unplug and rotary motions. Already a small rotation for instance by 10° may lock the spray nozzle 2 into the inner circumferential channel 30 of the main body 4.

Each of the two longitudinal slots 26 and 28, together with its adjacent segment of the inner circumferential channel 30 or an inner arcuate channel 30 constitutes an L-shaped locking path to receive and lock the locking protrusions 22 and 24 respectively. The channels may be replaced by slots and vice-versa.

In lieu of an inner circumferential channel 30 extending by 360°, channels or slots may be used that run only over part of the circumference of the wall of connector female 18. The channel 30 or the channels or slots may be fitted with stops 54 and/or wedge-shaped clamping surfaces 33 on which the locking protrusions 22 and 24 shall run or rest when the spray nozzle 2 is rotated in the female connection element 18. In this manner the rotation of the spray nozzle 2 shall be bounded and its angular locking position shall be defined. Being wedge-shaped, the clamping surfaces 33 assure reliable angular positioning of the spray nozzle 2.

The inner circumferential channel 30 (or slot or other substitute circumferential recess) comprises a rearward-facing locking surface 32 engaged from behind by the locking protrusions 22 or 24.

A resiliently compressible annular seal 34 such as an O-ring is inserted between a forward-facing transverse surface 36 in the wall of the female connection part 18 and a rearward-facing transverse surface 38 in the outside periphery of the spray nozzle 2. The annular seal 34 is situated between the locking protrusions 22, 24 and the rear end 40 of the spray nozzle 2. The annular seal 34 is partly compressed due to the axial bracing of the locking protrusions 22, 24 of the spray nozzle 2 at the rearward-facing locking surface 32 of the main body 4. As a result, the spray nozzle 2 is reliably sealed from the main body 4 and this spray nozzle 2 is held in jitter-free manner by the annular seal 34 in the main body 4.

Preferably the spray nozzle 2 is fitted with a male connection end segment 42 projecting rearward beyond the annular seal 34 into the coating-material duct 12 and resting without play and in sealing manner against the inner circumferential surface 44 of the coating-material duct 12. Consequently this inner circumferential surface 44 constitutes an extension of the female connection element 18. Preferably another outer circumferential segment 46 of the spray nozzle 2, situated in front of the locking protrusions 22, 24, also rests in jitter-free manner against the inner circumferential surface 48 of the female connection element wherein the locking path 26, 28, 30 is formed.

In the preferred embodiment of the invention, the spray nozzle 2 comprises a continuous axial coating-material borehole 50 designed at its rear as a valve seat 51 receiving a valve element 52, said borehole 50 illustratively flaring conically to the rear. Said valve element 52 is schematically shown by double-dots and dashes. Preferably said valve element is a conventional valve needle of the spray systems of the art.

The axial separation between the front edge of the locking protrusions 22, 24 to the rear edge of the annular seal 34 when latter rests against the transverse surface 36 of the main body 4 shall be larger in the uncompressed state of said seal than when it is compressed. In this manner, when being inserted into the continuous borehole 6, the spray nozzle 2 shall come into contact with the annular seal 34 before the locking protrusions 22, 24 move axially into the transverse plane containing the locking surface 32. To allow rotating the locking protrusions 22, 24 axially behind the locking surface 32, the spray nozzle 2 must be manually forced against the annular seal 34 whereby latter shall be resiliently compressed.

FIG. 5 shows an embodiment mode of the invention wherein the same or similar components of FIGS. 1 through 4 are denoted by the same reference numerals.

As in FIGS. 1 through 4, the distance x1 of FIG. 5 between the front edge of the locking protrusions 22, 24 and the rear edge of the uncompressed annular seal 34 is larger than the axial separation x2 between the rearward-facing locking surface 32 of the main body 4 and its forward-facing transverse surface 36 against which the annular seal 34 shall rest when the spray nozzle 2 has been mounted. FIG. 5 shows the annular seal 34 once in solid lines on the spray nozzle 2 and once in dashed lines in the main body 4.

FIG. 5 shows the front end segment 18 of the main body 4 constituting the female connection component 18 being fitted with two L-shaped clearances or slots that are mutually apart by 180° and that are open in the front end face. Said slots consist of a longitudinal slot element 26-1 and 28-1 running axially from the front end 16, of a transverse slot element 30-1 being connected to said longitudinal element's axially rear end in the circumferential direction, and of a forward-running short slot projection 56 connected to a circumferential end 54 of said slot element 30-1, the front end of said projection 56 constituting the locking surface 32. At the front end of the transverse slot element 30-1, the forward-running slot projection 56 constitutes an offset to index the locking protrusions 22 or 24. The hook-shaped and forward facing slot projection 56 is shorter than the resilient maximal axial compression excursion of the annular seal 34. The rearward-facing locking surface segment 32-1 of the transverse slot 30-1 is situated at an axial position at which the locking protrusion 22 or 24 compresses the annular seal 34 axially and elastically more forcefully than when said protrusion 22 or 24 rests against the locking surface 32. The axial separation x3 of the rearward-facing surface segment 32-1 is of a size in-between those of the other two separations x1 and x2.

1. A fluid spray system, comprising a spray nozzle (2) detachably affixed to a main body (4) which is crossed by at least one fluid duct (12) feeding fluid to the spray nozzle (2),
characterized in that
a separable rapid rotational connection is constituted between the spray nozzle (2) and the main body (4) whereby the rear end segment of the spray nozzle (2) is designed as the male connection element (19) and the main body (4) is designed at the front end of its fluid duct (12) as the female connection element (18) which receives the commensurately designed male connection element (19), in that the spray nozzle (2) comprises at least one locking protrusion (22, 24) projecting transversely from the male connection element (19), and in that at least one locking surface (32) facing the rear is constituted in the female connection element (18), at least one locking protrusion (22, 24) being rotatable into a position behind said surface (32) by rotating the spray nozzle (2) in its fully inserted axial position into the said female connection element in order that the spray nozzle shall be locked in said axial position.

2. Spray system as claimed in claim 1, characterized in that an L-shaped locking path (26, 28, 30,; 26-1, 28-1, 30-1) to receive and lock the minimum of one locking protrusion (22, 24) is constituted in the female connection element (18), one of the locking path's legs (26, 28, 26-1, 28-1) running in the longitudinal direction of the female connection element and issuing at the front in order to axially receive the locking protrusion (22, 24) and the other leg (30, 30-1) of the locking path and beginning at the first leg running in the circumferential direction and comprising the rearward-facing locking surface (32), the minimum of one locking protrusion (22, 24) of the connection element (19) inserted into the female connection element (18) being situated behind said surface (32).

3. Spray system as claimed in one of the above claims, characterized in that a resiliently compressible annular seal (34) is configured between a forward-facing transverse surface (38) constituted in the end segment (18) of the fluid duct (12) and a rearward-facing transverse surface (38) constituted at the spray nozzle (2) at a site between the minimum of one locking protrusion (22, 24) and the rear end of the spray nozzle (2), and in that the annular seal (34) is resiliently compressible due to the minimum of one locking protrusion (22, 24) of the spray nozzle (2) resting against the locking surface (32).

4. Spray system as claimed in one of the above claims, characterized in that the female connection element (18) is fitted with a stop surface (54) which is situated in the rotational path of the locking protrusion (22, 24) of the spray nozzle (2) and which thereby limits the angle of rotation of the spray nozzle (2) to less than 360°.

5. Spray system as claimed in one of the above claims, characterized in that the spray nozzle (2) comprises two locking protrusions (22, 24) diametrically apart by 180° and in that the main body (4) comprises two corresponding locking surfaces (32) which are diametrically apart by 180°.

6. Spray system as claimed in one of claims 3 through 4, characterized in that the spray nozzle (2) comprises an end segment which projects axially and rearward beyond the annular seal (34) to rest in play-free manner against the inner circumferential surface (48) of the fluid duct (12).

7. Spray system as claimed in one of the above claims, characterized in that the spray nozzle (2) is crossed by a continuous fluid borehole (6) and in that the rear end segment of the continuous borehole (50) is designed to be a valve seat (51) for a valve element (52).

8. Spray system as claimed in one of the above claims 3 through 7, characterized in that the locking surface (32) is adjacent to a partial locking surface (32-1) which also faces rearward and which is constituted at the female connection element (18) on the rotation excursion path of the spray nozzle (2) between latter's unlocked axial position and its locked angular position, in that the partial locking surface (32-1) is offset rearward farther than the locking surface (32), the annular seal (34) being axially more compressible by the partial locking surface (32-1) than by the locking surface (32), and in that an offset is constituted between the partial locking surface (32-1) and the locking surface (32) behind which the minimum of one locking protrusion (22, 24) may be axially latched.
